(19) United States
(12) Patent Application Publication
(10) Pub. No.: US 2016/0039623 A1
(43) Pub. Date: Feb. 11, 2016

(54) A DUST SUPPRESSION SYSTEM FOR LOADING SHIP HOLDS

(71) Applicant: FLINDERS PORTS PTY LIMITED, Port Adelaide, South Australia (AU)

(72) Inventors: Andrew Mark PELLIZZARI, Port Adelaide SA (AU); Daniel Edwin SLOAN, Port Adelaide SA (AU); Darren James FRANKLIN, Port Adelaide SA (AU); Grant Adrian MCALPINE, Port Adelaide SA (AU); Henry MINKUS, Port Adelaide SA (AU)

(21) Appl. No.: 14/782,052

(22) PCT Filed: May 24, 2013
(86) PCT No.: PCT/AU2013/000550

§ 371 Date: Oct. 2, 2015

(30) Foreign Application Priority Data
Apr. 3, 2013 (AU) 2013202369

(51) Int. Cl. B65G 69/18

(52) U.S. Cl. CPC B65G 69/188

(57) ABSTRACT

This invention relates to a dust suppression system for positioning in a container for a dusting material which creates a dust when agitated. The system comprises a means for forming an upper mist layer for preventing escape of the dust from the container, and a means for forming a lower mist layer below the upper mist layer for settling the dust into the container. In one form, the container is a hold of a ship, and the opening is a hatch for the hold.

### TECHNICAL FIELD

The present invention relates to the suppression of dust from dusting materials. Throughout the specification “dusting materials” is a term used to refer to material which contains a significant amount of dust, or which releases a dust when agitated such as by movement.

In a particular form the present invention relates to suppression of dusting materials during loading aboard, or unloading these from, a vessel.

### BACKGROUND

The loading and unloading of ships with dusting materials creates a significant amount of dust. Depending on the nature material, this dust is at least messy and therefore undesirable, and at worst dangerous.

Solutions for this problem have been previously proposed, which involved misting the space above the material, however the dust would still become airborne and escape the hatch.

It is against this background and the problems and difficulties associated therewith that the present invention has been developed.

Certain objects and advantages of the present invention will become apparent from the following description, taken in connection with the accompanying drawings, wherein, by way of illustration and example, an embodiment of the present invention is disclosed.

### SUMMARY

In a first aspect the present invention accordingly provides dust suppression system for use in a container for a dusting material which creates a dust when agitated, the system comprising a means for forming an upper mist layer for preventing escape of the dust from the container, and a means for forming a lower mist layer below the upper mist layer for settling the dust into the container.

In one form, the container is a hold of a ship. The invention is not so limited in application however, and may find use in other large containers for bulk materials.

In one form, in use, the upper mist layer suppresses the lower mist layer and prevents this from escaping the container.

In one form, the upper mist layer is formed within the container, above a stockpile of dusting material and below a level of an opening for the container. Where the container is a hold of a ship, the upper mist layer is formed within the hold and below a level of a hatch for the hold.

In one form, a height of the means for forming the upper mist layer above a bottom of the container is adjustable.

In one form, a height of the means for forming the lower mist layer above a bottom of the container is adjustable.

In one form, a spacing between the upper mist layer and the lower mist layer is adjustable.

In one form, a droplet size of the upper mist layer is equal to or larger than a particle of the dusting material. In this way, the upper mist layer will suppress the dusting material and contain this in the container.

In one form, a droplet size of the upper mist layer is equal to or larger than a droplet size of the lower mist layer. In this way, the upper mist layer will suppress the lower mist layer and contain this in the container.

In one form, a droplet size of the lower mist layer is sized to match a particle size of the dusting material. In this way, droplets of the lower mist layer attach to particles of the dusting material and force them to sink down into the hold.

When a droplet from the lower mist layer (or layers) attaches to the dusting material it weighs this down, so that it will drop and stay inside of the hold. What is more, droplets from the upper layer (or layers) of mist can also attach themselves to the dust particles.

In one form, the means for forming the upper mist layer extends about a perimeter of the container. Where the container is a hold of a ship, the means for forming the upper mist layer extends about a perimeter of the hold.

In one form, the system can be attached to one or more sides of the container.

In one form, the means for forming the lower mist layer extends about a perimeter of the container. Where the container is a hold of a ship, the means for forming the lower mist layer extends about a perimeter of the hold.

In a further aspect, the invention may be said to reside in a misting apparatus or mister for the above described dust suppression system, the mister comprising a means for forming an upper mist, and a means for forming a lower mist disposed below the means for forming the upper mist.

In one form, the means for forming the upper mist comprises at least one upper fluid delivery rail or line delivering fluid to an array of misting nozzles spaced apart along the upper fluid delivery rail.

In one form, the means for forming the lower mist comprises at least one lower fluid delivery rail or line delivering fluid to an array of misting nozzles spaced apart along the lower fluid delivery rail.

In one form, nozzles at or near ends of the fluid delivery rail are directed/angled so as to create a fanning effect of mist.

In one form, nozzles at or near ends of the fluid delivery rail produce droplets of a larger size than do nozzles at or near a centre of the fluid delivery rail.

In one form, the nozzles screw into the delivery rail.

In one form, the nozzles are movable laterally and/or vertically.

In one form, the misting apparatus further comprises a fluid supply line delivering fluid to each of the upper and lower fluid delivery rails or lines.

In one form, the fluid supply line intersects the upper and lower fluid delivery rails at a midpoint thereof.

In one form, the dust suppression system comprises a plurality of the misting apparatus suspended and spaced apart about the perimeter of the container. In an alternative, the dust suppression system comprises a single misting apparatus which extends around the perimeter of the container.

In one form, each of these apparatus is connected to a fluid supply, and the system further comprises a means for providing fluid to the or each apparatus under pressure.

In a further aspect, the invention may be said to reside in a dust suppression system for positioning in a hold of a ship, the system comprising means for forming an upper mist layer for preventing escape of dust from the hold, and means for forming a lower mist layer for settling dust into the hold.

A detailed description of one or more embodiments of the invention is provided below along with accompanying Figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details arc set forth in the following description in order to provide a thorough understanding of the present invention.

The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF THE DRAWINGS

An illustrative embodiment of the present invention will be discussed with reference to the accompanying drawings wherein:

FIG. 1 is a schematic illustration of a dust suppression system in use in a ship hold;

FIG. 2 is a front view of a misting apparatus or mister for the dust suppression system of FIG. 1;

FIG. 3 is a side view of the misting apparatus of FIG. 2;

FIG. 4 is a top view of the misting apparatus of FIG. 2;

FIG. 5 is a front view of an optional (depending on vessel type) hanging bracket for the misting apparatus of FIG. 2; and

FIG. 6 is a side view of the hanging bracket of FIG. 2.

In the following description, like reference characters designate like or corresponding parts throughout the several views of the drawings,

### TECHNICAL DESCRIPTION

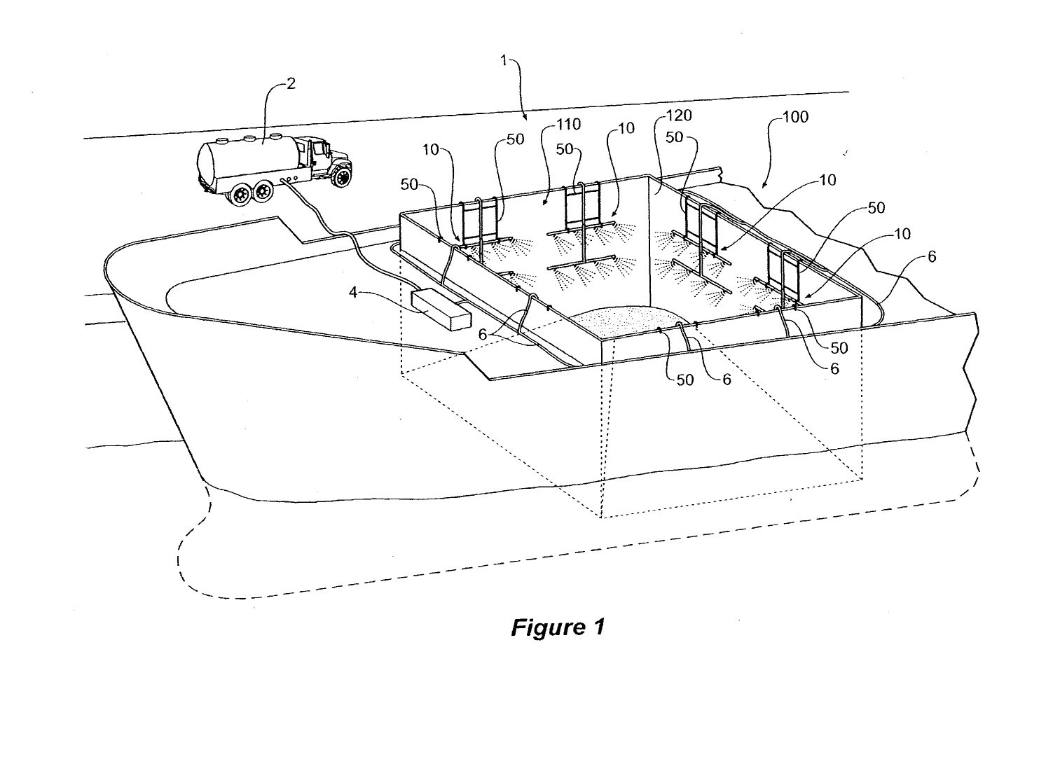

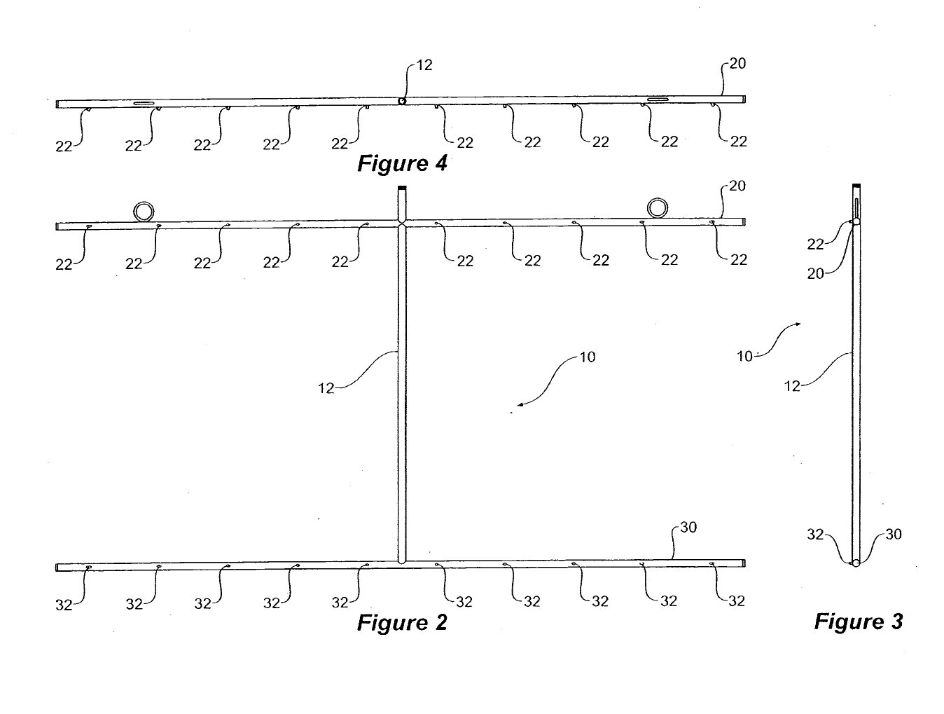

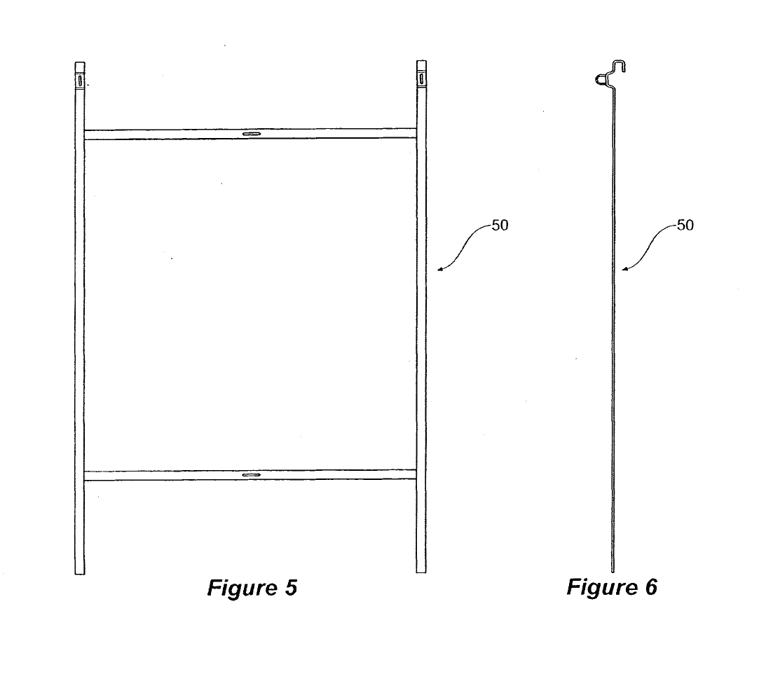

Referring now to FIG. 1, where there is illustrated a bulk storage ship 100 having a hold 110 with an uppermost hatch 120, via which a dusting material can be loaded and unloaded. During loading and unloading operations, a dust suppression system I may be employed to prevent dust created by this agitation of the dusting material, from escaping the hatch 120.

The dust suppression system 1 comprises a plurality of misting apparatus 10 suspended in the hold 110 and spaced apart about the perimeter of the hold 110.

A height of each misting apparatus 10 above a bottom or floor of the hold 110 can be adjusted. In this way each misting apparatus 10 can be positioned near to the floor during the early stages of loading, and then lifted as the level of material in the hold 110 raises.

Fresh water is drawn from a tank 2 or a mains water pipe. The pump 4, draws the water through a series of water filters, and supplies the filtered water under constant pressure to the misting apparatus 10 via hoses 6. The pump station 4 may be any one of fixed in position, portable, positioned on the wharf or jetty or mounted on a truck (i.e. a tanker).

Each misting apparatus 10 may be suspended in the hold 110 from the edge of the hatch 120 by hanging straps 50 (see FIG. 3).

As discussed above, the hanging straps 50 are adjustable in length to allow the misting apparatus 10 to be lowered close to the stockpile/bottom of the hold 110 and adjusted up the side of the hold 110 as the product is being loaded.

Each misting apparatus 10 comprises a rigid fluid supply line 12 extending vertically from a ‘quick-fit’ type connection with a hose 6, and from which there depends a horizontally extending upper fluid delivery rail 20, and a horizontally extending lower fluid delivery rail 30, which is below, parallel to, and spaced apart from the upper fluid delivery rail 20. Rigid fluid supply line 12 can be of varying length.

The system may employ multiple misting apparatus 10 and rails 20, 30 positioned up the side of the hold 110 depending on the amount and type of dusting material being generated during loading. Multiple layers of misting rails are also used to manage fugitive dusts, due to their particle size.

Referring now to FIG. 4, each fluid delivery rail 20 and 30 comprises an array of sockets 22 and 32 spaced apart along the rail. Each socket 22 and 32 is threaded so that a misting nozzle can be screwed into the rail.

The misting nozzles of the lower fluid delivery rail 30 are selected to produce a droplet which substantially matches a particle size of the dusting material.

The misting nozzles of the upper fluid delivery rail 20 are selected to produce a droplet which is equal to or larger than a droplet from the lower fluid delivery rail.

As an example, for Copper Concentrates, the nozzles will be set to produce droplets of the following sizes:

Upper nozzles—0.5 to 0.8 μm; and

Lower nozzles—0.3 to 0.5 μm.

The nozzles screw into the sockets in the fluid delivery rail 20 or 30 so that these may be changed if droplets of a different size are required to suppress dust of a different material, or for any other reason. For instance, nozzles at or near ends of the fluid delivery rail 20 or 30 can be selected to produce droplets of a larger size than do nozzles at or near a centre of the fluid delivery rail 20 or 30, or vice versa.

As can be seen in FIG. 4, nozzles positioned at or near ends of the fluid delivery rail 20 or 30 are angled outward to create a fanning effect of mist produced by mister 10. The closer a given nozzle is to the end of the fluid delivery rail, the greater the extent of its outward angle.

Nozzle spacing and angles shown in FIG. 3 and FIG. 4 are illustrative and adjustable, such as by blanking off some sockets to vary spacing.

In use, as dusting material is loaded into or unloaded from the hold (thereby creating dust), the water is pumped under continuous pressure from the tank 4 (or mains water pipe) through a series of water filtration systems, through the hoses 6 to the fluid supply line 12 of each misting apparatus 10, and then through the upper and lower fluid delivery rails 20 and 30 to the nozzles.

Together, the upper fluid delivery rails 20 of each misting apparatus 10 in the system I create an upper mist layer which extends right across the hold 110.

Similarly, together, the lower fluid delivery rails 30 of each misting apparatus 10 in the system 1 create a lower mist layer which extends right across the hold 110.

Droplets of the lower mist layer will be the same size or smaller than the dust particles so that the droplets attach to particles of the dusting material to weigh these down and force them to sink down into the hold 110.

With airflow in and around the hatch (due to weather conditions), very fine dust particles will escape from the hold 110 if only the lower mist layer is provided.

The upper mist layer (comprising equal or larger droplet sizes of the lower mist layer) suppresses the lower mist layer along with the dust, and prevents these from escaping the hold 110. In this way the system 1 according to the present invention is more effective at suppressing dust than was previous systems.

Moreover, the system I disclosed herein uses less water than previous systems, and leaves minimal water in the material which comes to rest in the hold 110.

It will be understood that the term “comprise” and any of its derivatives (eg. comprises, comprising) as used in this specification is to be taken to be inclusive of features to which it refers, and is not meant to exclude the presence of any additional features unless otherwise stated or implied.

The reference to any prior art in this specification is not, and should not be taken as, an acknowledgement of any form of suggestion that such prior art forms part of the common general knowledge.

Although an illustrative embodiment of the present invention has been described in the foregoing detailed description, it will be understood that the invention is not limited to the embodiment disclosed, but is capable of numerous rearrangements, modifications and substitutions without departing from the scope of the invention as set forth and defined by the following claims.

1. A dust suppression system for positioning in a container for a dusting material which creates a dust when agitated, the system comprising a means for forming an upper mist layer for preventing escape of the dust from the container, and a means for forming a lower mist layer below the upper mist layer for settling the dust into the container.

2. The dust suppression system of claim 1, wherein the container is a hold of a ship, the hold having a hatch.

3. The dust suppression system of claim 2, wherein the upper mist layer is formed within the hold and below a level of the hatch for the hold.

4. The dust suppression system according to claim 1, wherein a droplet size of the upper mist layer is larger than a particle of the dusting material.

5. The dust suppression according to claim 1, wherein a droplet size of the upper mist layer is equal to or larger than a droplet size of the lower mist layer.

6. The dust suppression system according to claim 1, wherein a droplet size of the lower mist layer is sized to match a particle size of the dusting material.

7. The dust suppression system according to claim 2, wherein the means for forming the upper mist layer extends about a perimeter of the hold.

8. The dust suppression system according to claim 2, wherein the means for forming the lower mist layer extends about a perimeter of the hold.

9. The dust suppression system according to claim 1, wherein a height of the means for forming the upper mist layer above a bottom of the container is adjustable.

10. The dust suppression according to claim 1, wherein a height of the means for forming the lower mist layer above a bottom of the container is adjustable.

11. A misting apparatus or mister for the dust suppression system of claim 1, the mister comprising a means for forming an upper mist, and a means for forming a lower mist disposed below the means for forming the upper mist.

12. The misting apparatus of claim 11, wherein the means for forming the upper mist comprises an upper fluid delivery rail delivering fluid to an array of misting nozzles spaced apart along the upper fluid delivery rail.

13. The misting apparatus as in claim 11, wherein the means for forming the lower mist comprises a lower fluid delivery rail delivering fluid to an array of misting nozzles spaced apart along the lower fluid delivery rail.

14. The misting apparatus as in claim 11, wherein nozzles at or near ends of the fluid delivery rail directed outward to create a fanning effect of mist.

15. The misting apparatus as in claim 11, wherein nozzles at or near ends of the fluid delivery rail produce droplets of a larger size than do nozzles at or near a center of the fluid delivery rail.

16. The misting apparatus as in claim 11, wherein the misting apparatus further comprises a fluid supply line delivering fluid to each of the upper and lower fluid delivery rails.

17. The misting apparatus as in claim 11, wherein the fluid supply line intersects the upper and lower fluid delivery rails at a midpoint thereof.

18. A dust suppression system comprising a plurality of the misting apparatus of claim 11, where said misting apparatus are suspended in the container between an opening and a bottom thereof, and spaced apart about the perimeter of the container.

19. The dust suppression system of claim 18, wherein each apparatus is connected to a fluid supply, and the system further comprises a means for providing fluid to the apparatus under constant pressure.

20. A dust suppression system for positioning about a hatch for a hold of a ship, the system comprising a means for forming an upper mist layer for preventing escape of a dust from the hold, and a means for forming a lower mist layer for settling the dust into the hold.
